(19) United States
(12) Patent Application Publication
(10) Pub. No.: US 2007/0036833 A1
(43) Pub. Date: Feb. 15, 2007

(54) Mosquito-repellant patch

(76) Inventor: Chih-Min Chen, Taoyuan Hsien (TW)

Correspondence Address: LEONG C LEI, PMB # 1008, 1867 YGNACIO VALLEY ROAD, WALNUT CREEK, CA, 94598, US

(21) Appl. No.: 11/203,169

(22) Filed: Aug. 15, 2005

(51) Int. Cl. A01N 25/00; A01N 65/00

(52) U.S. Cl. 424/405; 424/750

(57) ABSTRACT

A mosquito-repellent patch attached to any place desired by the user either on his body, personal belongings, or any other object is comprised of osmosis layer, lemon grass layer, binding layer and strip-off paper in sequence; the strip-off paper being removed for the patch to stick to any place as desired for the lemon grass to dissipate its flavor through the osmosis layer to fend off mosquitoes.

### BACKGROUND OF THE INVENTION

(a) Technical Field of the Invention

The present invention is related to a mosquito-repellent patch, and more particularly, to one that is readily to stick on human body, personal belongings, or any other object as desired to keep of mosquitoes.

(b) Description of the Prior Art

Neither a beast nor a snake, instead the mosquito has been accompanying the man. As a primary public enemy, public nuisance, mosquito is also the medium that distributes many diseases including cholera. Naturally, man starts to search for means to kill or repel the mosquito. Pesticide is popular, but it is at the same time hazardous to human health. Mosquito-repellent lotion is an option. It however is not practical to apply the lotion all over the body and all day long since the mosquito could actually bite any part of a human body, and the lotion when applied may irritate the skin or develop allergy.

### SUMMARY OF THE INVENTION

The primary purpose of the present invention is to provide a mosquito-repellent patch that is safe to use while effectively fending off the mosquito. To achieve the purpose, the present invention is comprised of multiple layers including an osmosis layer, a lemon grass layer, a binding layer and a strip-off paper in sequence. Wherein, the repellent is extracted from lemon grass, a natural mosquito repellent to slowly evaporate through the osmosis layer; the binding layer is provided on the back of the lemon grass to stick the patch to any place as desired; and the osmosis layer is patterned to facilitate increasing the evaporation area of the lemon grass.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention.

FIG. 2 is a schematic view showing the present invention as assembled.

FIG. 3 is a sectional view of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

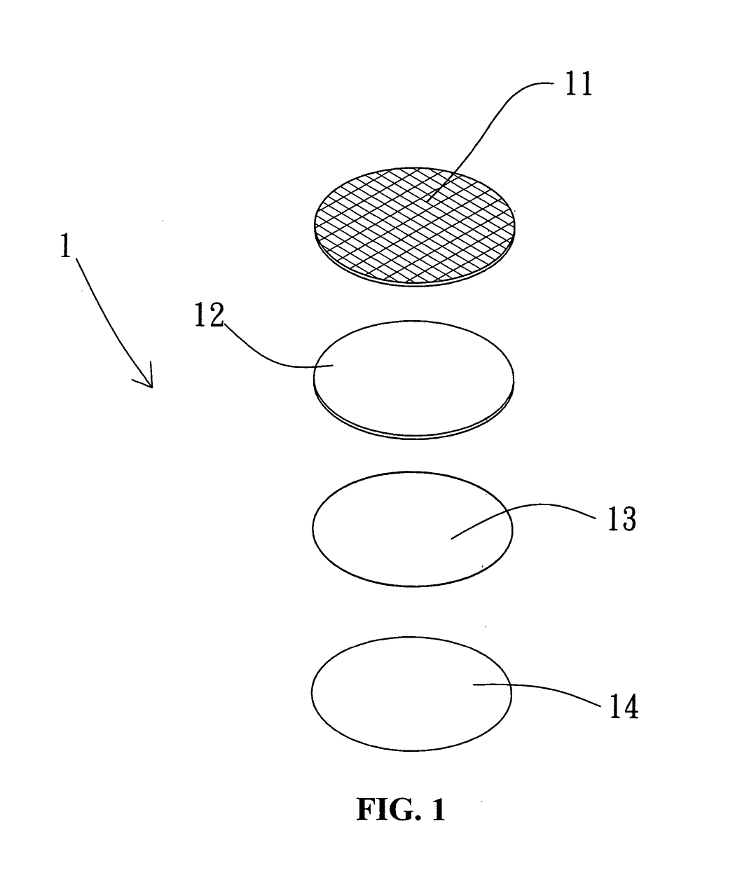

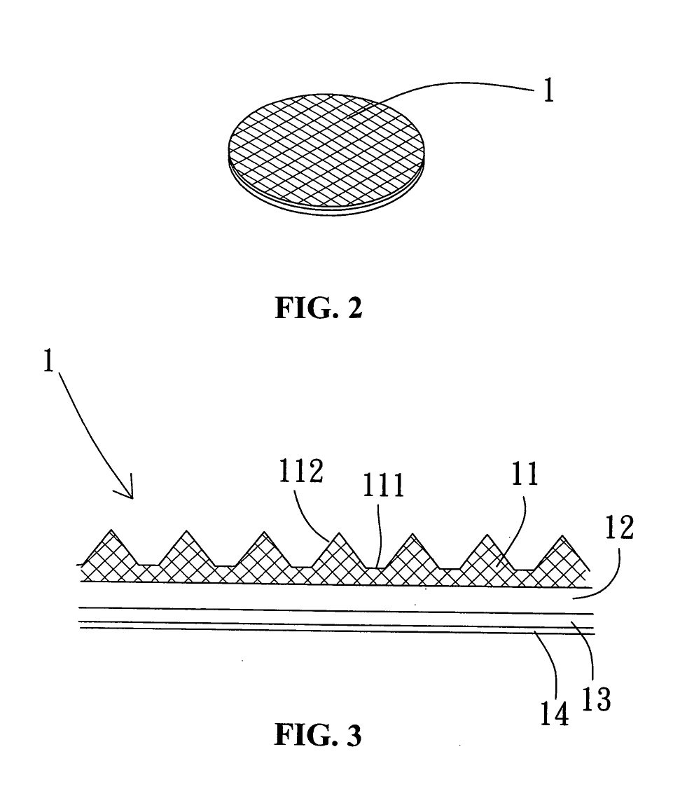

Referring to FIGS. 1, 2 and 3, a mosquito-repellent patch 1 of a preferred embodiment of the present invention is essentially comprised of an osmosis layer 11, a lemon grass layer 12, a binding layer 13, and a strip-off paper 14. Wherein, the osmosis layer 11 is made of non-woven fabric, PU film, or any other air permeable material that provides sparse gaps that is further patterned on its surface to increase the evaporation area as illustrated in FIG. 3. Variations among those pits 111 and nipples 112 produced on the surface of the osmosis layer 11 effectively increase the surface area, thus the evaporation area of the osmosis layer 11.

Extracts of Cymbopogon citrates, generally known as the lemon grass, are coated on the back of the osmosis 11 to make the lemon grass layer 12; a film of adhesion is applied on the back to the lemon grass layer to become the binding layer 13; and finally a piece of strip-off paper is adhered to the back of binding layer 13. In mass production, the mosquito-repellent patch is processed in sequence on a large sheet before being cut into the designated size of multiple individual patches by press.

In practical use, the strip-off paper is removed and stick with its binding layer 13 to anywhere on human body, clothes, handbag, tent, motor vehicle, or any other space that may be vulnerable to attack by mosquito.

It is to be noted that the lemon grass is a natural mosquito repellent without any side effects. The mosquito-repellent patch is environment friendly and will not cause any irritation or allergy to the user. Therefore, the present invention is safe and practical to use with significant economic benefits.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A mosquito-repellent patch comprised of multiple layers that can be stick to any place on human body, personal belongings or any other object that warrants to repel mosquitoes includes an osmosis layer, a lemon grass layer, a binding layer, and a strip-off paper laminated in sequence; the lemon grass extracts being coated to the back of the osmosis layer; the binding layer being applied to the back of the lemon grass layer; and the strip-off paper being adhered to the back of the binding layer; the osmosis layer being comprised of a non-woven fabric, PU film, or any other similar material that is air permeable and containing sparse gaps; and the surface of the osmosis layer being patterned to increase the evaporation area for the lemon grass.
